(19) United States
(12) Patent Application Publication
(10) Pub. No.: US 2025/0210900 A1
(43) Pub. Date: Jun. 26, 2025

(54) CONNECTOR

(71) Applicant: LS MTRON LTD., Anyang-si, Gyeonggi-do (KR)

(72) Inventor: Sang Jun OH, Anyang-si, Gyeonggi-do (KR)

(21) Appl. No.: 18/848,202

(22) PCT Filed: Apr. 17, 2023
(86) PCT No.: PCT/KR2023/005158

§ 371 Date: Sep. 18, 2024

(30) Foreign Application Priority Data
Apr. 19, 2022 (KR) 10-2022-0048275
Apr. 12, 2023 (KR) 10-2023-0048124

(51) Int. Cl. H01R 13/24; H01R 12/71

(52) U.S. Cl. CPC H01R 13/2407; H01R 12/716

(57) ABSTRACT

A connector is disclosed. A connector according to one aspect of the present disclosure may comprise: a plug insulation body having a length in a first direction and a width in a second direction orthogonal to the first direction; and a plurality of plug contacts coupled to the plug insulation body, coupled to a plurality of receptacle contacts provided on a receptacle member to be electrically connected, respectively, and arranged to be spaced apart from each other along the first direction, wherein any one of each pair of the plug contacts arranged to be adjacent to each other is in contact with a first receptacle contact portion operatively movably provided on the receptacle contact at one side in the second direction, and the other thereof is in contact with the first receptacle contact portion at the other side in the second direction.

### CROSS-REFERENCE TO RELATED APPLICATION

This application is a National Stage of International Application No. PCT/KR2023/005158, filed Apr. 17, 2023, which claims priority to and the benefit of Korean Patent Application No. 10-2022-0048275, filed Apr. 19, 2022, and Korean Patent Application No. 10-2023-0048124, filed Apr. 12, 2023, the disclosures of which are incorporated herein by reference in its entirety.

### FIELD

The present disclosure relates to a connector, and more particularly, to a connector having a structure capable of achieving miniaturization in size while improving manufacturing convenience and electrically connection reliability.

### BACKGROUND

Recently, with the trend of miniaturization of electronic devices, a circuit substrate and a connector for electrically connecting the circuit substrate to other members are also miniaturizing. On the other hand, the amount of information processed by the electronic devices is increasing, and the number of contacts provided in the circuit substrate or the connector is increasing. Accordingly, the demand for a miniaturized connector is increasing.

An example of the above connector is a B2B connector (Board To Board Connector). The B2B connector is formed to have a thin thickness, and may electrically connect module substrates such as a camera module and a mobile phone LCD module. As the trend of miniaturization of portable electronic devices, the demand for the B2B connector is also increasing.

The B2B connector is configured to include a plug and a receptacle. The plug and the receptacle are each configured to include a plurality of contacts spaced apart from each other in the longitudinal direction. The contacts included in the plug and the receptacle each may be in contact with each other, and a state of electrical connection between the modules provided with the B2B connector may be formed.

As the plug and the receptacle are miniaturized, the distance between the plurality of contacts arranged in the plug and the receptacle are reduced. Accordingly, the difficulty of a soldering work for coupling a plurality of contacts to the module substrate increases, and the soldering portions of each contact may come in contact with each other, causing electrical interference.

Therefore, there is a need for a connector capable of improving manufacturing convenience and electrical connection reliability while reducing the distance between the plurality of contacts in order to miniaturize the plug and the receptacle.

Korean Patent Registration No. 10-0906079b1 (2009 Jul. 6)

Korean Patent Registration No. 10-0937009b1 (2010 Jan. 15)

### SUMMARY

The present disclosure is to solve the above problems, and the purpose of the present disclosure is to provide a connector having a structure that may be miniaturized in size.

Another purpose of the present disclosure is to provide a connector having a structure that may reduce an interval between contacts.

Another purpose of the present disclosure is to provide a connector having a structure that may prevent each contact from being arbitrarily electrical connected.

Another purpose of the present disclosure is to provide a connector having a structure that may improve manufacturing convenience.

Another purpose of the present disclosure is to provide a connector having a structure that may easily inspect a manufacturing result.

The technical problems of the present disclosure are not limited to the above-mentioned problems, and other technical problems not mentioned will be clearly understood by those skilled in the art to which the present disclosure pertains from the following description.

According to an aspect of the present disclosure, there is provided a connector including: a plug insulator 100 having a length in a first direction and having a width in a second direction orthogonal to the first direction; and a plurality of plug contacts 300 coupled to the plug insulator 100, respectively coupled to and electrically connected to a plurality of receptacle contacts 700 provided on a receptacle 20, and spaced apart from each other along the first direction, wherein one of each pair of the plug contacts 300 arranged to be adjacent to each other is in contact with a first receptacle contactor 711 operatively movably provided on the receptacle contacts 700 at one side in the second direction, and the other thereof is in contact with the first receptacle contactor 711 at the other side in the second direction.

According to another aspect of the present disclosure, there is provided a connector including: a receptacle insulator 500 having a length in a first direction and having a width in a second direction orthogonal to the first direction; and a plurality of receptacle contacts 700 coupled to the receptacle insulator 500, respectively coupled to and electrically connected to a plurality of plug contacts 300 provided on a plug 10, and spaced apart from each other along the first direction, wherein a first receptacle contactor 711 operatively movably provided on one of each pair of the receptacle contacts 700 arranged to be adjacent to each other is in contact with a plug contactor 310 of the plug contact 300 at one side in the second direction, and the first receptacle contactor 711 operatively movably provided on the other thereof is in contact with the plug contactor 310 at the other side in the second direction.

According to the above configuration, the connector according to an embodiment of the present disclosure can be miniaturized in size.

In addition, according to the above configuration, the connector according to an embodiment of the present disclosure can reduce the interval between contacts.

In addition, according to the above configuration, the connector according to an embodiment of the present disclosure can prevent each contact from being arbitrarily electrical connected.

In addition, according to the above configuration, the connector according to an embodiment of the present disclosure can improve manufacturing convenience.

In addition, according to the above configuration, the connector according to an embodiment of the present disclosure can easily inspect the manufacturing result.

It should be understood that the effects of the present disclosure are not limited to the above effects, but include all effects that can be inferred from the detailed description of the present disclosure or the configuration of the disclosure described in the claims.

### BRIEF DESCRIPTION OF THE DRAWINGS

FIG. 1 is a perspective view showing a plug provided in a connector according to an embodiment of the present disclosure.

FIG. 2 is a front view showing the plug of FIG. 1.

FIG. 3 is a plan view showing the plug of FIG. 1.

FIG. 4 is a bottom view showing the plug of FIG. 1.

FIG. 5 is an exploded perspective view showing a configuration of the plug of FIG. 1.

FIG. 6 is a perspective view showing a configuration of the plug of FIG. 1.

FIG. 7 is a plan view showing a configuration of the plug of FIG. 1.

FIG. 8 is a bottom view showing a configuration of the plug of FIG. 1.

FIG. 9 is an A-A cross-sectional view showing a configuration of the plug of FIG. 1.

FIG. 10 is a perspective view showing a plug contact provided in the plug of FIG. 1.

FIGS. 11 and 12 are plan views showing the plug contact of FIG. 10 and an arrangement structure thereof.

FIG. 13 is a plan view showing a plug PCB pattern provided in the plug of FIG. 1.

FIG. 14 is a perspective view showing a receptacle provided in a connector according to an embodiment of the present disclosure.

FIG. 15 is a front view showing the receptacle of FIG. 14.

FIG. 16 is a plan view showing the receptacle of FIG. 14.

FIG. 17 is a bottom view showing the receptacle of FIG. 14.

FIG. 18 is an exploded perspective view showing the receptacle of FIG. 14.

FIG. 19 is a perspective view showing a configuration of the receptacle of FIG. 14.

FIG. 20 is a plan view showing a configuration of the receptacle of FIG. 14.

FIG. 21 is a bottom view showing a configuration of the receptacle of FIG. 14.

FIG. 22 is a B-B cross-sectional view showing a configuration of the receptacle of FIG. 14.

FIG. 23 is a C-C cross-sectional view showing a configuration of the receptacle of FIG. 14.

FIG. 24 is a perspective view showing a receptacle contact provided in the receptacle of FIG. 14.

FIGS. 25 and 26 are plan views showing the receptacle contact of FIG. 24 and an arrangement structure thereof.

FIG. 27 is a plan view showing a receptacle PCB pattern provided in the receptacle of FIG. 14.

### DETAILED DESCRIPTION

Hereinafter, exemplary embodiments of the present disclosure will be described in detail so that those of ordinary skill in the art can readily implement the present disclosure with reference to the accompanying drawings. The present disclosure may be embodied in many different forms and is not limited to the embodiments set forth herein. In the drawings, parts unrelated to the description are omitted for clarity of description of the present disclosure, and throughout the specification, same or similar reference numerals denote same elements.

In the following description, in order to clarify the features of the present disclosure, descriptions of some components may be omitted.

The term “communication” used in the following description means that one or more members are connected to each other in fluid communication. In an embodiment, the communication may be formed by a member such as a pipe, a pipe, or a pipe. In the following description, communication may be used in the same sense that one or more members are “fluidly connected” to each other.

The term “electrical connection” used in the following description means that one or more members are connected to each other to transfer a current or electric signal. In an embodiment, the electrical connection may be formed in the form of a wire by a wire member or wireless such as Bluetooth, Wi-Fi, and RFID. In an embodiment, the electrical connection may include the meaning of “communication”.

The terms “upper side”, “lower side”, “left side”, “right side”, “front side”, and “rear side” used in the following description will be understood with reference to the coordinate system shown throughout the accompanying drawings.

Specifically, “left side” and “right side” may be defined in the X-axis direction, “front side” and “rear side” may be defined in the Y-axis direction, and “upper side” and “lower side” may be defined in the Z-axis direction.

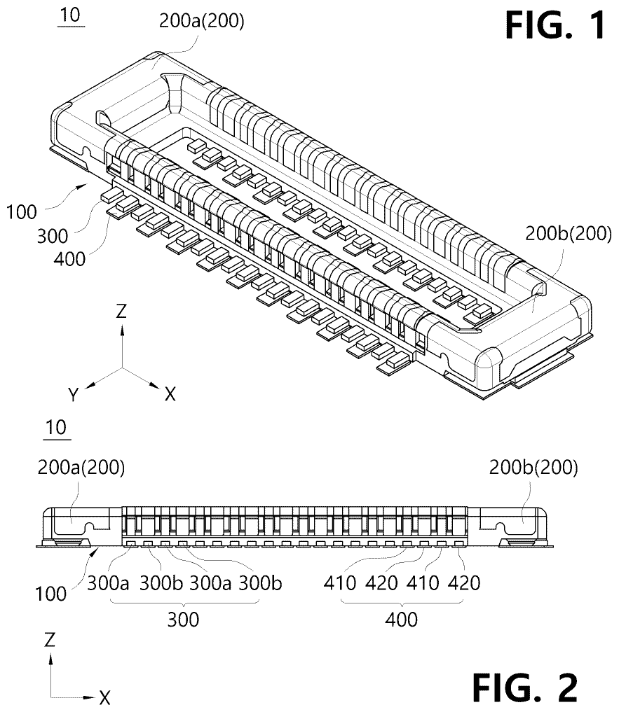

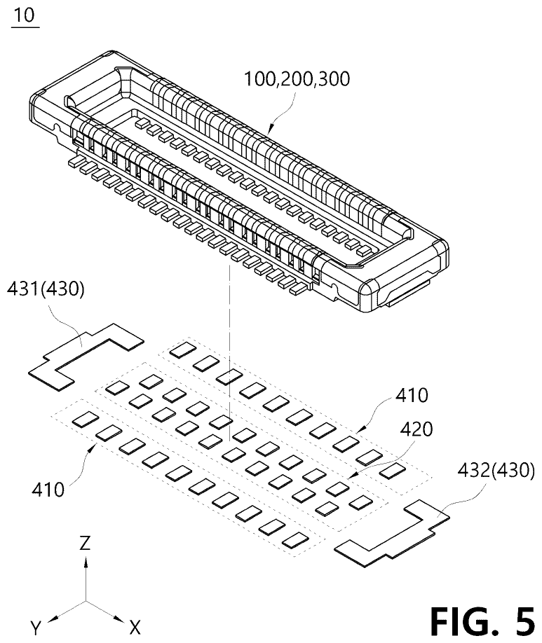

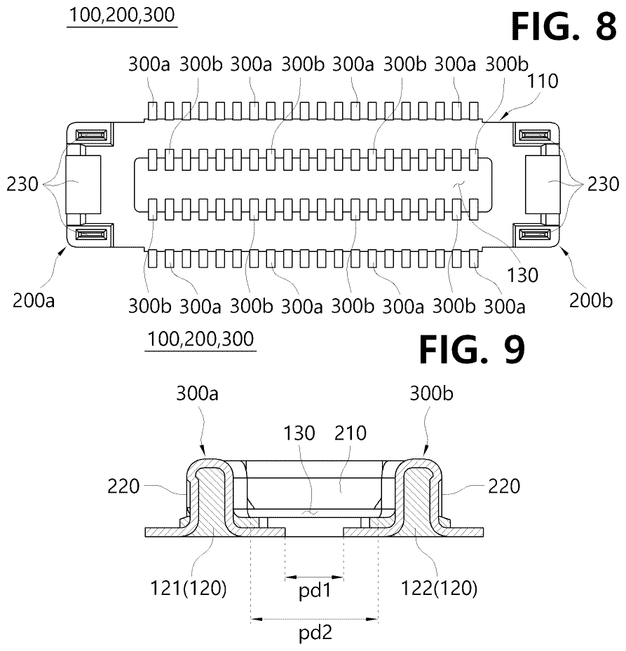

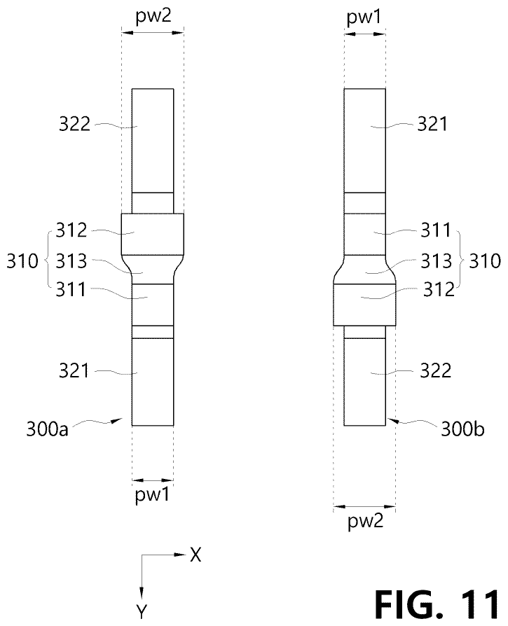

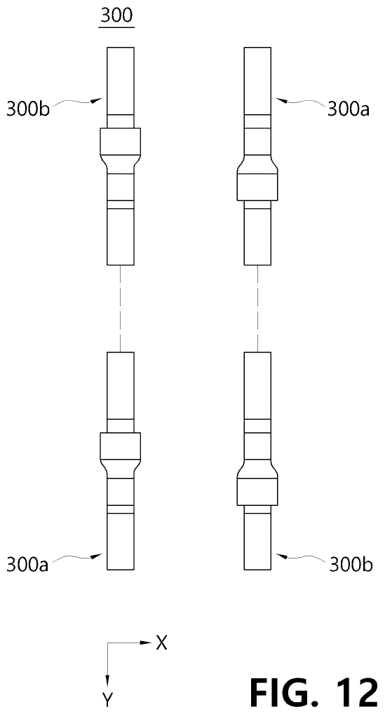

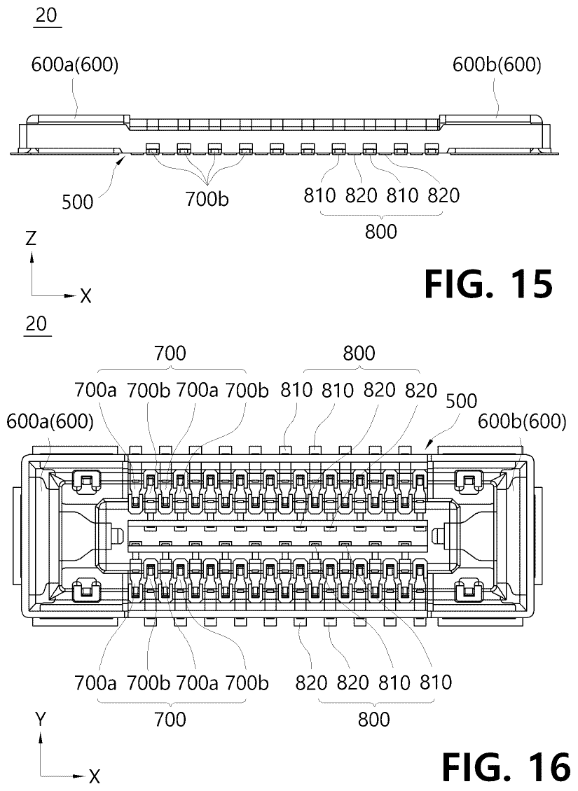

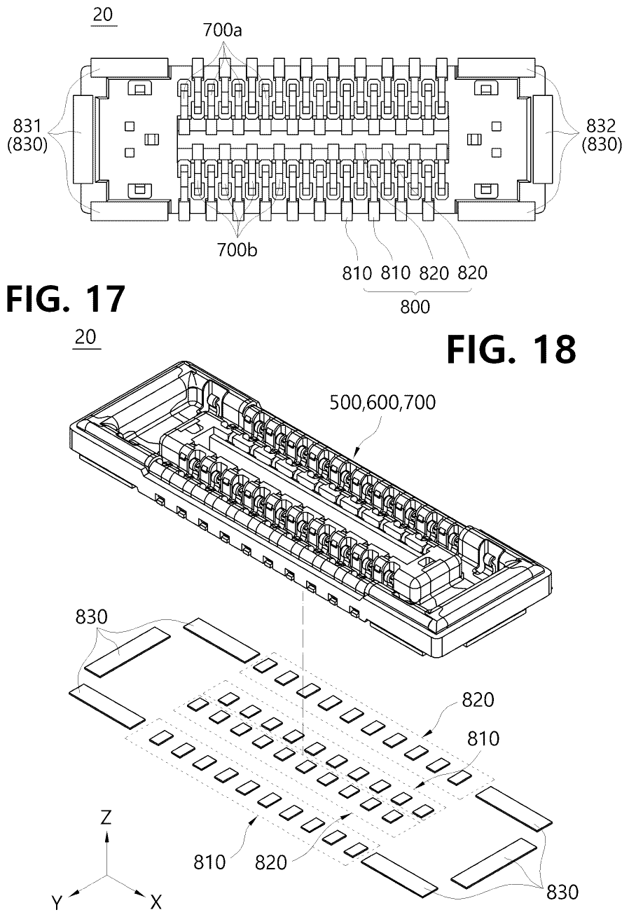

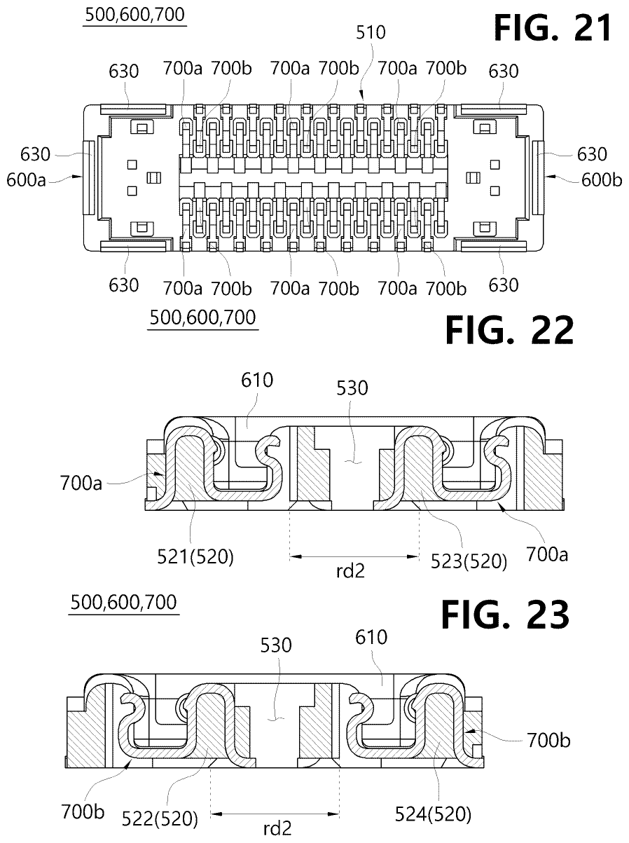

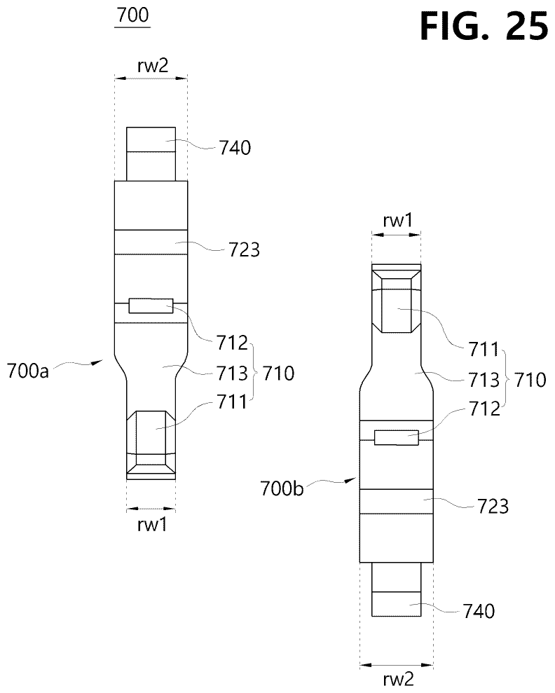

Referring to FIGS. 1 to 13, a plug 10 provided in a connector according to an embodiment of the present disclosure is illustrated. Referring to FIGS. 14 to 27, a receptacle 20 provided in a connector according to an embodiment of the present disclosure is illustrated.

The plug 10 may be coupled to one module substrate (not shown). In addition, the receptacle 20 may be coupled to the other module substrate (not shown). The plug 10 and the receptacle 20 may be coupled to each other and electrically connected to each other. Accordingly, the one module substrate (not shown) and the other module substrate (not shown) may be electrically connected.

Specifically, the plug 10 may be coupled to the receptacle 20 after being flipped in the state shown in FIG. 1. The coupling process of the plug 10 and the receptacle 20 is well-known technology, and thus a detailed description will be omitted.

The connector according to the embodiment of the present disclosure described below is a B2B connector. However, it will be understood that the technical features of the plug 10 and the receptacle 20 provided in the connector according to the embodiment of the present disclosure may be applied to any type of connector including a plurality of plug contacts 300 or a plurality of receptacle contacts 700.

In an embodiment shown in FIGS. 1 to 13, the plug 10 includes a plug insulator 100, plug hold-down 200, a plug contact 300, and plug PCB pattern 400.

The plug insulator 100 forms an outer shape of the plug 10. The plug insulator 100 is coupled to other components of the plug 10 to support them. The plug insulator 100 is formed of an electrically insulating material to prevent arbitrary electrical connection between each component coupled to the plug insulator 100.

The plug insulator 100 is coupled to the plug hold-down 200. The plug insulator 100 is partially covered by the plug hold-down 200.

The plug insulator 100 is coupled to the plug contact 300. A plurality of plug contacts 300 may be spaced apart from each other and coupled to the plug insulator 100.

In the illustrated embodiment, the plug insulator 100 includes a plug insulator body 110, a plug support wall 120, and a plug through-hole 130.

The plug insulation body 110 forms a body of the plug insulator 100. The plug insulation body 110 extends in the longitudinal direction of the plug 10 and in the left and right directions in the illustrated embodiment. In other words, the plug insulation body 110 is formed to have a length in the X-axis direction.

The plug insulation body 110 is formed to have a width in the Y-axis direction, that is, in the front and rear directions in the illustrated embodiment. In this case, the length of the plug insulation body 110 in the left and right directions is longer than the width in the front and rear directions.

A space is formed inside the plug insulation body 110. In the space, a receptacle support wall 520 provided in the receptacle 20 is accommodated. The space may be formed to correspond to the shape of the plug insulation body 110. In the illustrated embodiment, the space is formed to have a length in the X-axis direction and a width in the Y-axis direction.

Each of the edges of the plug insulation body 110 located at each end in the Y-axis direction, that is, a front end and a rear end, may be defined as the plug support wall 120.

The plug support wall 120 constitutes a portion of the plug insulation body 110. The plug support wall 120 may be defined as each of the edges of the plug insulation body 110 in the longitudinal direction. In the illustrated embodiment, the plug support wall 120 constitutes the front side and the rear side edges of the plug insulation body 110.

The plug support wall 120 may be formed in a shape corresponding to the shape of the plug insulation body 110. In the illustrated embodiment, the plug support wall 120 is formed to extend long in the X-axis direction, that is, in the left and right directions.

The plug support wall 120 is coupled to the plug contact 300. The plug support wall 120 supports the plug contact 300. A plurality of plug contacts 300 may be disposed to be spaced apart from each other in the longitudinal direction, that is, the X-axis direction, of the plug support wall 120. The plurality of plug contacts 300 coupled to the plug support wall 120 are electrically spaced apart from each other, so that any electrical connection between them may be prevented.

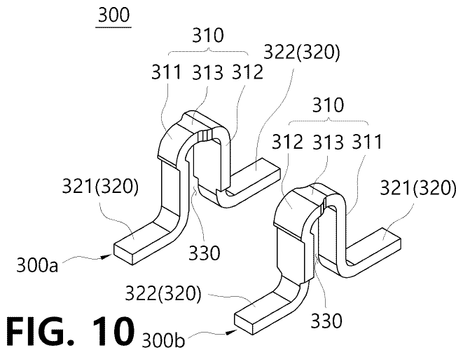

The plug support wall 120 may have a shape corresponding to the shape of the plug contact 300. In the illustrated embodiment, the plug support wall 120 is formed to have a width in the Y-axis direction and a height in the Z-axis direction, corresponding to the shape of the plug coupling space 330 formed inside the plug contact 300 (see FIGS. 9 and 10).

The plug support walls 120 may be provided in plural. The plurality of plug support walls 120 may be disposed to be spaced apart from each other in the width direction, that is, the Y-axis direction, of the plug insulation body 110. The plurality of plug support walls 120 may be coupled to the plurality of plug contacts 300 to support them, respectively.

In the illustrated embodiment, two plug support walls 120 are provided, including a first plug support wall 121 and a second plug support wall 122. The first plug support wall 121 and the second plug support wall 122 are disposed to face each other with a space formed inside the plug insulation body 110 interposed therebetween.

The first plug support wall 121 is located to be biased to one side in the width direction of the plug insulation body 110, that is, to the front side in the illustrated embodiment. The first plug support wall 121 is coupled to a plurality of plug contacts 300 located in the front side.

The second plug support wall 122 is located to be biased to the other side in the width direction of the plug insulation body 110, that is, to the rear side in the illustrated embodiment. The second plug support wall 122 is coupled to a plurality of plug contacts 300 located on the rear side.

The plug through-hole 130 is formed between the first plug support wall 121 and the second plug support wall 122.

The plug through-hole 130 is defined as an opening formed inside the plug insulator 100. The plug through-hole 130 is formed to penetrate in the height direction of the plug insulation body 110, that is, in the Z-axis direction in the illustrated embodiment. The plug through-hole 130 extends in the longitudinal direction of the plug insulation body 110, that is, the X-axis direction in the illustrated embodiment.

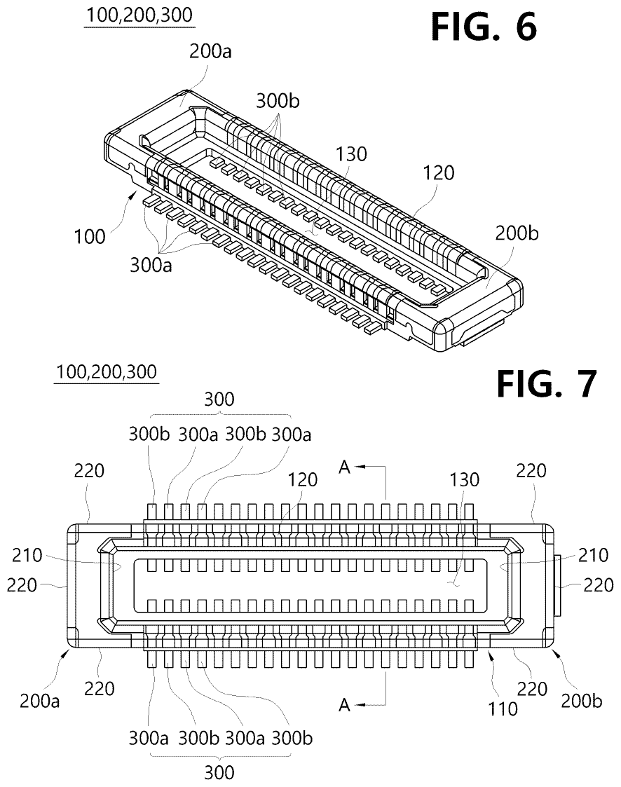

The plug through-hole 130 partially accommodates the plug contact 300 coupled to the plug support wall 120. In other words, as best shown in FIGS. 6 to 9, one end of the portion of the plug contact 300 toward the inside is accommodated in the plug through-hole 130.

The plug through-hole 130 serves as a window to check the coupling state between the one end of the plug contact 300 and the plug PCB pattern 400.

That is, an operator or inspection device may check the coupling state between the one end of the plug contact 300 and the plug PCB pattern 400 through the plug through-hole 130. In addition, the operator or inspection device may check the results of manufacturing the plug 10, such as whether the plurality of plug contacts 300 and the plug PCB pattern 400 each coupled to each other are in contact with each other through the plug through-hole 130.

The plug hold-down 200 is coupled to the plug insulator 100 to reinforce the rigidity of the plug insulator 100. In addition, the plug hold-down 200 is coupled to the plug PCB pattern 400 in a state of being coupled to the plug insulator 100 to increase a coupling force between the plug 10 and the module substrate (not shown).

Furthermore, the plug hold-down 200 may be in contact with and electrical connected to the receptacle hold-down 600. A current of greater magnitude may be passed through the plug hold-down 200 compared to the current passed through the plug contact 300.

The plug hold-down 200 may be formed of an electrically conductive material. In addition, the plug hold-down 200 may be formed of a material of high rigidity. In the above embodiment, the plug hold-down 200 is electrical connected to the receptacle hold-down 600, and at the same time, the rigidity of the plug insulator 100 and the coupling force between the plug 10 and the module substrate (not shown) may be increased.

In an embodiment, the plug hold-down 200 may be formed of a metal material such as copper (Cu) or an alloy including the same.

The plug hold-downs 200 may be provided in plural. The plurality of plug hold-downs 200 may be spaced apart from each other and may be coupled to the plug insulation body 110 at different positions. In the illustrated embodiment, two plug hold-downs 200 are provided, including a first plug hold-down 200a and a second plug hold-down 200b.

The first plug hold-down 200a is coupled to one end of the plug insulation body 110 in the longitudinal direction (i.e., the X-axis direction), that is, to the left end in the illustrated embodiment. The second plug hold-down 200b is coupled to the other end of the plug insulation body 110 in the longitudinal direction (i.e., the X-axis direction), that is, the right end in the illustrated embodiment.

The first plug hold-down 200a is in contact with and electrically connected to a first receptacle hold-down 600a. The second plug hold-down 200b is in contact with and electrically connected to a second receptacle hold-down 600b.

In the illustrated embodiment, the plug hold-down 200 includes a plug hold-down inner surface 210, a plug hold-down outer surface 220, and a plug hold-down coupler 230.

The plug hold-down inner surface 210 constitutes a portion of the plug hold-down 200. The plug hold-down inner surface 210 may be defined as a portion accommodated in a space formed inside the plug insulation body 110 among the portions of the plug hold-down 200. The plug hold-down inner surface 210 is configured to surround the inner surface of the plug insulation body 110 in the longitudinal direction.

The plug hold-down inner surface 210 is continuous with the plug hold-down outer surface 220.

The plug hold-down outer surface 220 constitutes another portion of the plug hold-down 200. The plug hold-down outer surface 220 may be defined as a portion covering the outer surface of the plug insulation body 110 among the portions of the plug hold-down 200. The plug hold-down outer surface 220 is configured to cover the outer surface in the width direction and the outer surface in the length direction of the plug insulation body 110, respectively.

The plug hold-down coupler 230 is a portion where the plug hold-down 200 is coupled to the plug PCB pattern 400. The plug hold-down coupler 230 may be exposed to one side of the plug insulation body 110 in the Z-axis direction, that is, to the outside of the bottom side of the plug insulation body 110 in the illustrated embodiment.

The plug hold-down couplers 230 may be provided in plural. The plurality of plug hold-down couplers 230 may be coupled to the plurality of plug hold-down PCB patterns 430, respectively. In the illustrated embodiment, the plug hold-down coupler 230 consists of a pair spaced apart in the Y-axis direction and one located between the pair.

The plug contact 300 is in contact with and electrical connected to the receptacle contact 700. The plug contact 300 performs a function of electrically connecting a module substrate (not shown) coupled to the plug 10 and a module substrate (not shown) coupled to the receptacle 20. The plug contact 300 may exchange electrical signals or currents with the receptacle contact 700.

The plug contact 300 may be formed of an electrically conductive material. In addition, the plug contact 300 may be formed of a material having a predetermined elasticity. In an embodiment, the plug contact 300 may be formed of a metal material such as copper or an alloy including the same.

The plug contact 300 is coupled to the plug insulator 100. The plug contact 300 may be supported by being coupled to the plug support wall 120.

The plug contacts 300 may be provided in plural. The plurality of plug contacts 300 may be arranged to be spaced apart from each other in the longitudinal direction of the plug support wall 120, that is, the X-axis direction in the illustrated embodiment.

In the plug 10 according to an embodiment of the present disclosure, a plurality of plug contacts 300 may be disposed to be spaced apart by a minimum distance. Accordingly, the length of the plug 10, that is, the length in the X-axis direction in the illustrated embodiment, may be reduced.

In addition, the plug 10 according to an embodiment of the present disclosure may prevent unintended contact and electrical conduction between the plurality of plug contacts 300 disposed adjacent to each other or the plug PCB patterns 400 coupled to each of the plurality of plug contacts 300. To this end, as will be described later, the plurality of plug contacts 300 may be coupled to the plug PCB patterns 400 at different locations along the arrangement direction thereof.

In this case, as will be described later, the plurality of plug contacts 300 may include a first plug contact 300a where the first plug contact mounter 321 is located at one side, that is, the front side, in the Y-axis direction, and a second plug contact 300b where the second plug contact mounter 322 is located at the one side, that is, the front side, in the Y-axis direction. The first and second plug contacts 300a and 300b are alternately disposed along the direction in which the plurality of plug contacts 300 are spaced apart from each other in parallel, that is, the X-axis direction.

Therefore, when viewed from the viewpoint of the plug contact mounter 320, it will be understood that the first plug contact mounter 321 and the second plug contact mounter 322 are alternately disposed along the X-axis direction.

The first plug contacts 300a and the second plug contacts 300b are different in the direction of coupling with the plug support wall 120 and the position of coupling with the plug PCB pattern 400, but their structures are the same. Therefore, common parts in the following description will be described by collectively named the first and second plug contacts 300a and 300b as the plug contact 300.

In the illustrated embodiment, the plug contact 300 includes a plug contactor 310, a plug contact mounter 320, and a plug coupling space 330.

The plug contactor 310 is a portion where the plug contact 300 is coupled to the receptacle contact 700. The plug contactor 310 is in contact with and electrically connected to the receptacle contactor 710 of the receptacle contact 700. The plug contactor 310 constitutes a portion of the plug contact 300.

The plug contactor 310 is coupled to the plug support wall 120. The plug contactor 310 is configured to cover a portion of the plug support wall 120 in the height direction, and a portion of the plug support wall 120 in the width direction. In the embodiment shown in FIG. 9, the plug contactor 310 is configured to cover an upper, a front side, and a rear side of the plug support wall 120.

The plug contactor 310 partially surrounds the plug coupling space 330. In the illustrated embodiment, the plug contactor 310 surrounds an upper side, a front side, and a rear side of the plug coupling space 330. Accordingly, the plug support wall 120 accommodated in the plug coupling space 330 may also be surrounded by the plug contactor 310 on the upper, front, and rear sides thereof.

In the illustrated embodiment, the plug contactor 310 includes a first plug contactor 311, a second plug contactor 312, and a plug contact connector 313.

The first plug contactor 311 constitutes a portion where the plug contactor 310 is in contact with the receptacle contactor 710. The first plug contactor 311 is in contact with and electrical connected to the first receptacle contactor 711 or the second receptacle contactor 712.

The first plug contactor 311 is formed to be rounded to be convex toward the outside. In other words, the first plug contact 311 extends curved.

The first plug contactor 311 is continuous with the first plug contact mounting part 321. The first plug contactor 311 is continuous with the second plug contactor 312 through the plug contact connector 313.

The second plug contactor 312 constitutes another portion where the plug contactor 310 is in contact with the receptacle contactor 710. The second plug contactor 312 is in contact with and electrically connected to the first receptacle contactor 711 or the second receptacle contactor 712.

The second plug contactor 312 is formed to be rounded to be convex toward the outside. In other words, the second plug contact 312 extends curved.

The second plug contactor 312 is continuous with the second plug contact mounter 322. The second plug contactor 312 is continuous with the first plug contactor 311 through the plug contact connector 313.

The plug contact connector 313 forms another configuration of the plug contactor 310. The plug contact connector 313 extends between the first plug contactor 311 and the second plug contactor 312. The plug contact connector 313 is continuous with the first plug contactor 311 and the second plug contactor 312, respectively.

The plug contact connector 313 may be formed to have different widths along its extension direction. In the illustrated embodiment, the plug contact connector 313 extends along the Y-axis direction, and the length of the plug contact connector 313 in the X-axis direction is changed along the extension direction.

That is, as shown in FIGS. 10 to 12, a portion of the plug contact connector 313 that is continuous with the first plug contactor 311, that is, the front side thereof, is formed to have a width of a first plug width pw1. In this case, the first plug width pw1 may be defined as the width of the first plug contactor 311 or the first plug contact mounter 321.

In addition, a portion of the plug contact connector 313 that is continuous with the second plug contactor 312, that is, the rear side, is formed to have a width of a second plug width pw2. In this case, the second plug width pw2 may be defined as the width of the second plug contactor 312 or the second plug contact mounter 322.

At this time, as shown in the drawing, the first plug width pw1 is formed shorter than the second plug width pw2. Therefore, the width of the plug contact connector 313 of the first plug contact 300a increases toward the rear side, and the width of the plug contact connector 313 of the second plug contact 300b decreases toward the rear side.

Therefore, even if the separation distance between the first and second plug contacts 300a and 300b located adjacent to each other is reduced, contact between the plug contactor 310 may be prevented. Accordingly, the plurality of plug contacts 300 may be electrically insulated while being spaced apart by a minimum distance.

The plug contact mounter 320 is a portion where the plug contact 300 is coupled to the plug PCB pattern 400. The plug contact mounter 320 is exposed to the outside of the plug insulation body 110 or to the plug through-hole 130.

The plug contact mounter 320 is continuous with the plug contactor 310. In the illustrated embodiment, the end portion of the plug contact mounter 320 in the Y-axis direction is in contact with the plug contactor 310.

The plug contact mounter 320 may be provided in plural. The plurality of plug contact mounters 320 may be continuous with the first and second plug contactors 312, respectively. In the illustrated embodiment, the plug contact mounter 320 include a first plug contact mounter 321 continuous with the first plug contactor 311 and a second plug contact mounter 322 continuous with the second plug contactor 312.

The first plug contact mounter 321 of the first plug contact 300a is located on one side of the plug insulation body 110 in the width direction (i.e., that is, in the X-axis direction), this is, at the front side in the illustrated embodiment. Accordingly, the second plug contact mounter 322 of the first plug contact 300a is located on the other side of the plug insulation body 110 in the width direction (i.e., that is, in the Y-axis direction), this is, at the rear side in the illustrated embodiment.

Likewise, the first plug contact mounter 321 of the second plug contact 300b is located on the other side of the plug insulation body 110 in the width direction (i.e., the Y-axis direction), that is, on the rear side in the illustrated embodiment. Accordingly, the second plug contact mounter 322 of the second plug contact 300b is located on one side of the plug insulation body 110 in the width direction (i.e., that is, in the Y-axis direction), this is, at the front side in the illustrated embodiment.

Any one of the first and second plug contactors 311 and 312 may be coupled to the plug PCB pattern 400. In addition, the other of the first and second plug contactors 311 and 312 may be maintained in a state that it is not coupled to the plug PCB pattern 400. In other words, only one of the first and second plug contacts 311 and 312 included in the single plug contact 300 is coupled to the plug PCB pattern 400.

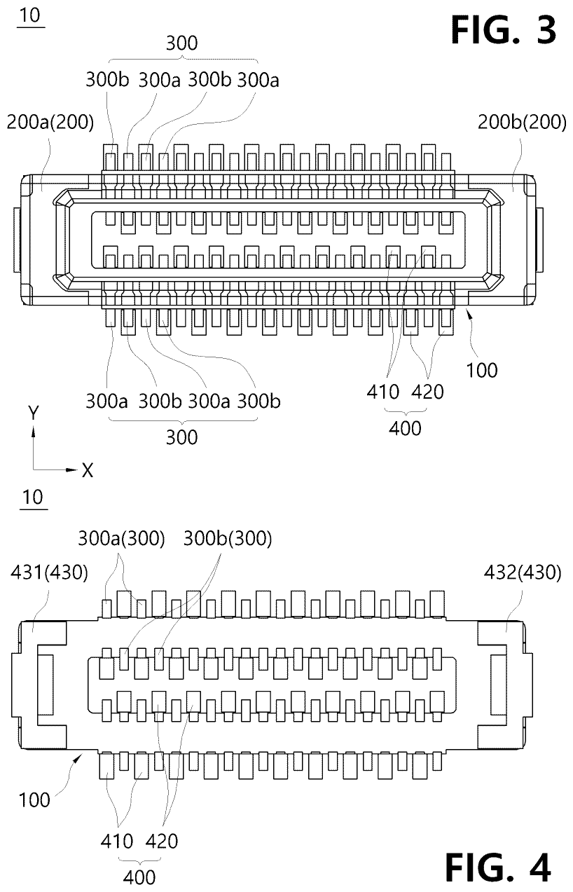

As shown in FIGS. 3 and 4, the first plug contact 300a has a second plug contact mounter 322 located on the rear side coupled to the first and second plug contact PCB patterns 410 and 420, respectively. In addition, the second plug contact 300b has a first plug contact mounter 321 located on the front side coupled to the first and second plug contact PCB patterns 410 and 420, respectively.

Therefore, a plug contact mounter 320 coupled to the plug PCB pattern 400 and a plug contact mounter 320 not coupled to the plug PCB pattern 400 are alternately arranged along the longitudinal direction, that is, in the X-axis direction, of the plug 10.

In other words, any one of the plug contact mounters 320 disposed adjacent to each other along the X-axis direction is coupled to the plug PCB pattern 400, and the other is not coupled to the plug PCB pattern 400.

Therefore, the first and second plug contact PCB patterns 410 and 420 are disposed to face each other with the plug contact mounter 320 interposed therebetween along the X-axis direction. Accordingly, the adjacent first and second plug contact PCB patterns 410 and 420 may be sufficiently spaced apart, so that any contact or electrical conduction between them may be prevented. This will be described in detail below.

The first plug contact mounter 321 of the first plug contact 300a coupled to the first plug support wall 121 is exposed to the front side of the plug insulation body 110. The second plug contact mounter 322 of the first plug contact 300a coupled to the first plug support wall 121 is exposed to the plug through-hole 130.

The first plug contact mounter 321 of the second plug contact 300a coupled to the second plug support wall 122 is exposed to the rear side of the plug insulation body 110. The second plug contact mounter 322 of the second plug contact 300b coupled to the second plug support wall 122 is exposed to the plug through-hole 130.

The plug coupling space 330 is a portion where the plug contact 300 is coupled to the plug support wall 120. The plug coupling space 330 is defined to be partially surrounded by the plug contactor 310. In the illustrated embodiment, an upper side, a front side, and a lower side of the plug coupling space 330 are surrounded by the plug contactor 310. A bottom side of the plug coupling space 330 may be opened, so that the plug support wall 120 may be accommodated.

As shown in FIGS. 10 to 12, the first and second plug contacts 300a and 300b may be alternately disposed along the X-axis direction. In addition, the first and second plug contacts 300a and 300b may be alternately disposed along the Y-axis direction.

As the first and second plug contacts 300a and 300b are alternately disposed along the X-axis direction and the Y-axis direction, the first and second plug contacts 311 and 312 and the first and second plug contact mounters 321 and 322 are also alternately disposed along the X-axis direction and the Y-axis direction. Furthermore, the first and second plug contact PCB patterns 410 and 420 coupled to the first and second plug contact mounters 321 and 322 may also be alternately disposed along the X-axis direction and the Y-axis direction.

As a result, the electrical connection reliability may be maintained while the first and second plug contacts 300a and 300b adjacent to each other are spaced apart by a minimum distance. Accordingly, the size of the plug 10, particularly the length of the X-axis direction, may be reduced.

Meanwhile, as shown in FIG. 9, the first and second plug contacts 300a and 300b disposed in parallel along the Y-axis direction may be disposed to be spaced apart by a predetermined distance.

In this case, the distance between the second plug contact mounter 322 located at the rear side of the first plug contact 300a coupled to the first plug support wall 121 and the first plug contact mounter 321 located at the front side of the second plug contact 300b coupled to the second wall 122 may be defined as the first plug distance pd1. In addition, the length of the plug through-hole 130 in the Y-axis direction may be defined as the second plug distance pd2.

The first plug distance pd1 is preferably formed long enough so that the first and second plug contact PCB patterns 410, 420 coupled to any one of the first and second plug contact mounters 321, 322 facing each other along the Y-axis direction are not in contact with the other. In addition, the first plug distance pd1 is formed to be less than or equal to the second plug distance pd2 such that the first and second plug contact mounters 321, 322 are preferably at least partially exposed through the plug through-hole 130.

The plug PCB pattern 400 couples the plug 10 with a module substrate (not shown). Specifically, the plug PCB pattern 400 couples the plug hold-down 200 and the plug contact 300 to a module substrate (not shown).

The plug PCB pattern 400 may be formed in an arbitrary shape capable of coupling the plug hold-down 200 and the plug contact 300 to the module substrate (not shown). In an embodiment, the plug PCB pattern 400 may be configured in the form of soldering.

The plug PCB pattern 400 may be formed in plural. The plurality of plug PCB patterns 400 may be coupled to the plug hold-down 200 and the plug contact 300, respectively. In the illustrated embodiment, the plug PCB pattern 400 includes a first plug contact PCB pattern 410, a second plug contact PCB pattern 420, and a plug hold-down PCB pattern 430.

The first plug contact PCB pattern 410 is coupled to the first and second plug contacts 300a and 300b. The first plug contact PCB pattern 410 is coupled to a portion of the plurality of first and second plug contacts 300a, 300b located in the plug through-hole 130.

The first plug contact PCB pattern 410 may be provided in plural. The plurality of first plug contact PCB patterns 410 may be alternately coupled to the plurality of plug contact mounters 320 along the X-axis direction. In other words, the plug contact mounter 320 coupled to the first plug contact PCB pattern 410 and the plug contact mounter 320 not coupled to the first plug contact PCB pattern 410 are alternately disposed along the X-axis direction.

In addition, the plurality of first plug contact PCB patterns 410 may be alternately coupled to the plurality of plug contact mounters 320 along the Y-axis direction. In other words, the plug contact mounters 320 coupled with to first plug contact PCB patterns 410 and the plug contact mounters 320 not coupled with the first plug contact PCB pattern 410 are alternately arranged along the Y-axis direction.

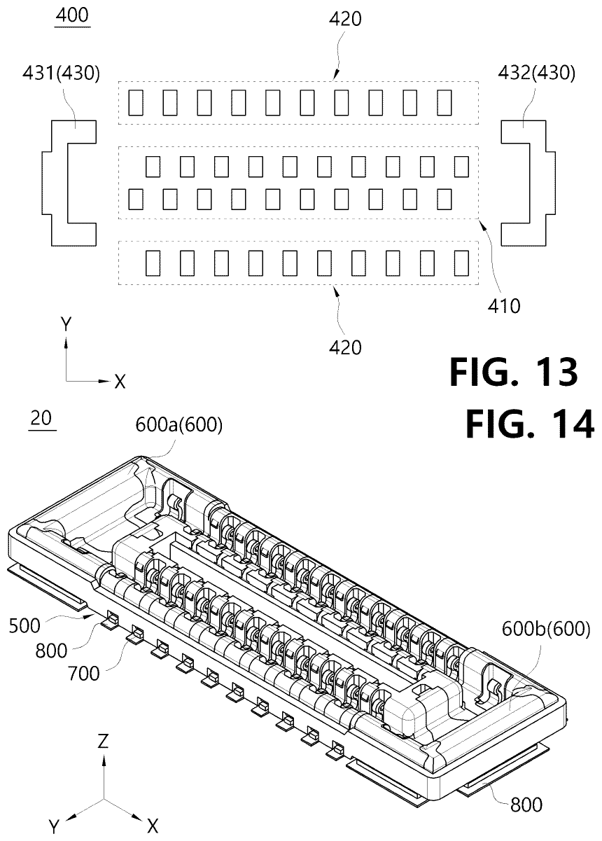

Therefore, as best shown in FIG. 13, the plurality of first plug contact PCB patterns 410 may be disposed to be spaced apart from each other along the X-axis direction and the Y-axis direction. As a result, an arbitrary contact or electrical connection between the first plug contact PCB patterns 410 located adjacent to each other may be prevented.

The second plug contact PCB patterns 420 is coupled to the first and second plug contacts 300a and 300b. The second plug contact PCB patterns 420 is coupled to another portion of the plurality of first and second plug contacts 300a and 300b located outside the plug insulation body 110.

The second plug contact PCB pattern 420 may be provided in plural. The plurality of second plug contact PCB patterns 420 may be alternately coupled to the plurality of plug contact mounters 320 along the X-axis direction. In other words, the plug contact mounters 320 coupled to the second plug contact PCB patterns 420 and the plug contact mounters 320 not coupled to the first plug contact PCB patterns 410 are alternately arranged along the X-axis direction.

In addition, the plurality of second plug contact PCB patterns 420 may be alternately coupled to the plurality of plug contact mounters 320 along the Y-axis direction. In other words, the plug contact mounters 320 coupled to the second plug contact PCB patterns 420 and the plug contact mounters 320 not coupled to the first plug contact PCB patterns 410 are alternately arranged along the Y-axis direction.

Therefore, as best shown in FIG. 13, the plurality of second plug contact PCB patterns 420 may be disposed to be spaced apart from each other along the X-axis direction and the Y-axis direction. As a result, an arbitrary contact or electrical connection between the second plug contact PCB patterns 420 located adjacent to each other may be prevented.

In this case, the singular first and second plug contact PCB patterns 410 and 420 may be disposed to be spaced apart from each other along the Y-axis direction.

The plug hold-down PCB pattern 430 is coupled to the plug hold-down 200. The plug hold-down PCB pattern 430 is coupled to the plug hold-down coupler 230 to increase the coupling force between the plug insulator 100 and the plug hold-down 200.

The plug hold-down PCB pattern 430 may be provided in plural. The plurality of plug hold-down PCB patterns 430 may be coupled to the plurality of plug hold-down couplers 230 provided in the plurality of plug hold-downs 200a and 200b, respectively.

In the illustrated embodiment, the plug hold-down PCB patterns 430 includes first and second plug hold-down PCB patterns 431 and 432. The first plug hold-down PCB pattern 431 is coupled to the plug hold-down coupler 230 of the first plug hold-down 200a and the second plug hold-down PCB pattern 432 is coupled to the plug hold-down coupler 230 of the second plug hold-down 200b, respectively.

The plug hold-down PCB pattern 430 may be disposed to be spaced apart from the first and second plug contact PCB patterns 410 and 420. In the illustrated embodiment, the plug hold-down PCB patterns 430 are disposed along the X-axis direction to be spaced apart from the first and second plug contact PCB patterns 410 and 420, respectively.

In the embodiment shown in FIGS. 14 to 27, receptacle 20 includes a receptacle insulator 500, a receptacle hold-down 600, a receptacle contact 700, and a receptacle PCB pattern 800.

The receptacle insulator 500 forms an outer shape of the receptacle 20. The receptacle insulator 500 is coupled to other components of the receptacle 20 to support them. The receptacle insulator 500 may be formed of an electrically insulating material to prevent arbitrary electrical connection between each component coupled to the receptacle insulator 500.

The receptacle insulator 500 is coupled to the receptacle hold-down 600. The receptacle insulator 500 is partially covered by the receptacle hold-down 600.

The receptacle insulator 500 is coupled to the receptacle contact 700. A plurality of receptacle contacts 700 may be spaced apart from each other and coupled to the receptacle insulator 500.

In the illustrated embodiment, the receptacle insulator 500 includes a receptacle insulation body 510, a receptacle support wall 520, a receptacle through-hole 530, and a receptacle connection wall 540.

The receptacle insulation body 510 forms a body of the receptacle insulator 500. The receptacle insulation body 510 extends in the longitudinal direction of the receptacle 20 and in the left and right directions in the illustrated embodiment. In other words, the receptacle insulation body 510 is formed to have a length in the X-axis direction.

The receptacle insulation body 510 is formed to have a width in the Y-axis direction, that is, in the front and rear directions in the illustrated embodiment. In this case, the length of the receptacle insulation body 510 in the left and right directions is longer than the width in the front and rear directions.

A space is formed inside the receptacle insulation body 510. In the space, a receptacle support wall 520 and a receptacle connection wall 540 are located. The space may be formed to correspond to the shape of the receptacle insulation body 510. In the illustrated embodiment, the space is formed to have a length in the X-axis direction and a width in the Y-axis direction.

Each of the edges of the receptacle insulation body 510 located at each end in the Y-axis direction, that is, a front end and a rear end, may be defined as the receptacle support wall 520.

The receptacle support wall 520 constitutes a portion of the receptacle insulation body 510. The receptacle support wall 520 may be defined as a configuration disposed in the inner space of the receptacle insulation body 510 and each edge in the longitudinal direction of the receptacle insulation body 510. In the illustrated embodiment, the receptacle support wall 520 constitutes the front side and the rear side edges of the receptacle insulation body 510 and a wall that is disposed in the inner space of the receptacle insulation body 510.

The receptacle support wall 520 may be formed in a shape corresponding to the shape of the receptacle insulation body 510. In the illustrated embodiment, the receptacle support wall 520 is formed to extend long in the X-axis direction, that is, in the left and right directions.

The receptacle support wall 520 is coupled to the receptacle contact 700. The receptacle support wall 520 supports the receptacle contact 700. A plurality of receptacle contacts 700 may be disposed to be spaced apart from each other in the longitudinal direction, that is, the X-axis direction, of the receptacle support wall 520. The plurality of receptacle contacts 700 coupled to the receptacle support wall 520 are electrically spaced apart from each other, so that any conduction between them can be prevented.

The receptacle support wall 520 may have a shape corresponding to the shape of the receptacle contact 700. In the illustrated embodiment, the receptacle support wall 520 is formed to have a width in the Y-axis direction and a height in the Z-axis direction, corresponding to the shape of the receptacle coupling space 730 formed inside the receptacle contact 700 (see FIG. 22).

The receptacle support wall 520 may be provided in plural. The plurality of receptacle support walls 520 may be disposed to be spaced apart from each other in the width direction, that is, the Y-axis direction, of the receptacle insulation body 510. The plurality of receptacle support walls 520 may be coupled to the plurality of receptacle contacts 700 to support them, respectively.

In the embodiment shown, four receptacle support walls 520 are provided, including a first receptacle support wall 521, a second receptacle support wall 522, a third receptacle support wall 523, and a fourth receptacle support wall 524.

The first receptacle support wall 521 and the second receptacle support wall 522 are disposed to face each other with the receptacle contact 700 located on one side, that is, the front side, in the Y-axis direction, interposed therebetween. The third receptacle support wall 523 and the fourth receptacle support wall 524 are disposed to face each other with the receptacle contact 700 located on the other side, that is, the rear side, in the Y-axis direction, interposed therebetween.

In addition, the second receptacle support wall 522 and the third receptacle support wall 523 are disposed to face each other with the receptacle through-hole 530 interposed therebetween.

Therefore, it will be understood that the first to fourth receptacle support walls 521, 522, 523, and 524 are spaced apart from each other along the width direction, that is, the Y-axis direction, of the receptacle insulation body 510.

The first receptacle support wall 521 is located to be biased to one side in the width direction of the receptacle insulation body 510 and to the front side in the illustrated embodiment. The first receptacle support wall 521 is coupled to a portion of the plurality of receptacle contacts 700 located on the front side.

The second receptacle support wall 522 is spaced apart from the first receptacle support wall 521 in the Y-axis direction to surround the receptacle through-hole 530 on one side, that is, front side in the illustrated embodiment. The second receptacle support wall 522 is coupled to the rest of the plurality of receptacle contacts 700 located on the front side.

The third receptacle support wall 523 is spaced apart from the second receptacle support wall 522 in the Y-axis direction to surround the receptacle through-hole 530 on the other side, that is, the rear side in the illustrated embodiment. The third receptacle support wall 523 is disposed to face the second receptacle support wall 522 with the receptacle through-hole 530 interposed therebetween. The third receptacle support wall 523 is coupled to a portion of the plurality of receptacle contacts 700 located on the rear side.

The fourth receptacle support wall 524 is located on the other side of the receptacle insulation body 510 in the width direction, that is, on the rear side in the illustrated embodiment. The fourth receptacle support wall 524 is coupled to the rest of the plurality of receptacle contacts 700 located on the rear side.

A receptacle through-hole 530 is formed between the second receptacle support wall 522 and the third receptacle support wall 523.

The receptacle through-hole 530 is defined as an opening formed inside the receptacle insulator 500. The receptacle through-hole 530 is formed to penetrate in a height direction of the receptacle insulation body 510, that is, in the Z-axis direction in the illustrated embodiment. The receptacle through-hole 530 extends in the longitudinal direction of the receptacle insulation body 510, that is, the X-axis direction in the illustrated embodiment.

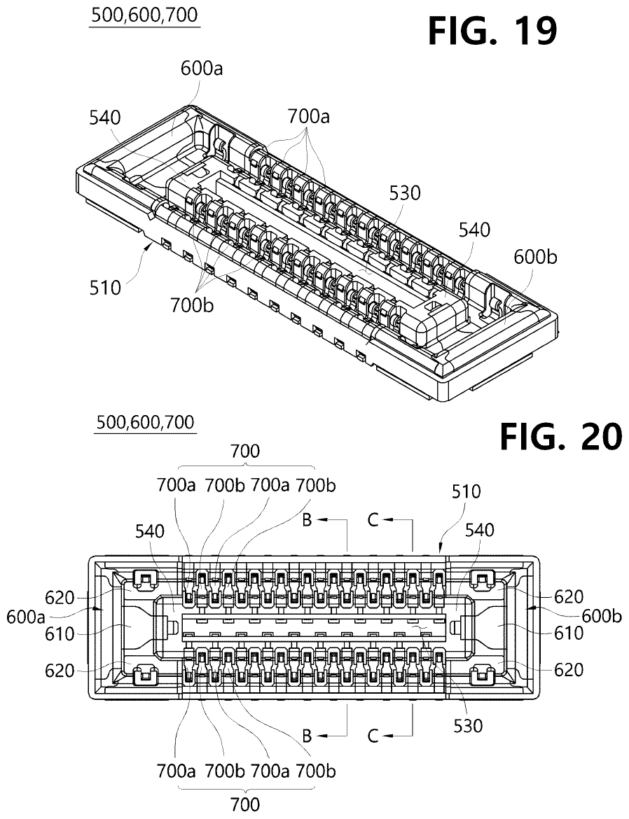

The receptacle through-hole 530 partially accommodates the receptacle contact 700 coupled to the receptacle support wall 520. In other words, as best shown in FIGS. 19 to 21, one end of the portion of the receptacle contact 700 toward the inside is accommodated in the receptacle through-hole 530.

The receptacle through-hole 530 serves as a window to check the coupling state between the one end of the receptacle contact 700 and the receptacle PCB pattern 800.

That is, the operator or the inspection device may check the coupling state between the one end of the receptacle contact 700 and the receptacle PCB pattern 800 through the receptacle through-hole 530. In addition, the operator or the inspection device may check the results of manufacturing the receptacle 20, such as whether the receptacle PCB pattern 800 and the plurality of receptacle contacts 700 each coupled to each other are in contact with each other through the receptacle through-hole 530.

The receptacle hold-down 600 is coupled to the receptacle insulator 500 to reinforce the rigidity of the receptacle insulator 500. In addition, the receptacle hold-down 600 is coupled to the receptacle PCB pattern 800 in a state of being coupled to the receptacle insulator 500 to increase a coupling force between the receptacle 20 and the module substrate (not shown)

Furthermore, the receptacle hold-down 600 may be in contact with and electrical connected to the plug hold-down 200. A current of greater magnitude may be passed through the receptacle hold-down 600 compared to the current passed through the receptacle contact 700.

The receptacle hold-down 600 may be formed of an electrically conductive material. In addition, the receptacle hold-down 600 may be formed of a material of high rigidity. In the above embodiment, the receptacle hold-down 600 is electrical connected to the receptacle hold-down 600, and at the same time, the rigidity of the receptacle insulator 500 and the coupling force between the receptacle 20 and the module substrate (not shown) may be increased.

In an embodiment, the receptacle hold-down 600 may be formed of a metal material such as copper (Cu) or an alloy including the same.

The receptacle hold-downs 600 may be provided in plural. The plurality of receptacle hold-downs 600 may be spaced apart from each other and may be coupled to the receptacle insulation body 510 at different positions. In the illustrated embodiment, two the receptacle hold-down 600 are provided, including a first receptacle hold-down 600a and a second receptacle hold-down 600b.

The first receptacle hold-down 600a is coupled to one end of the receptacle insulation body 510 in the longitudinal direction (i.e., the X-axis direction), that is, to the left end in the illustrated embodiment. The second receptacle hold-down 600b is coupled to the other end of the receptacle insulation body 510 in the longitudinal direction (i.e., the X-axis direction), that is, the right end in the illustrated embodiment.

The first receptacle hold-down 600a is in contact with and electrically connected to the first receptacle hold-down 600a. The second receptacle hold-down 600b is in contact with and electrically connected to the second receptacle hold-down 600b.

In the illustrated embodiment, receptacle hold-down 600 includes an upper receptacle hold-down 610, a side receptacle hold-down 620, and a receptacle hold-down coupler 630.

The upper receptacle hold-down 610 constitutes a portion of the receptacle hold-down 600. The upper receptacle hold-down 610 may be defined as a portion accommodated in a space formed inside the receptacle insulation body 510 among the portions of the receptacle hold-down 600. The upper receptacle hold-down 610 is configured to partially surround the surface surrounding the space from the bottom of the receptacle insulation body 510.

The upper receptacle hold-down 610 is continuous with the side receptacle hold-down 620.

The side receptacle hold-down 620 constitutes another portion of the receptacle hold-down 600. The side receptacle hold-down 620 may be defined as a portion covering the inner surface of the receptacle insulation body 510 among the portions of the receptacle hold-down 600. The side receptacle hold-down 620 is configured to surround the inner surface of the receptacle insulation body 510 in the width direction, respectively.

The receptacle hold-down coupler 630 is a portion where the receptacle hold-down 600 is coupled to the receptacle PCB pattern 800. The receptacle hold-down coupler 630 may be exposed to one side of the receptacle insulation body 510 in the Z-axis direction, that is, to the outside of the bottom side of the receptacle insulation body 510 in the illustrated embodiment and may be coupled to the receptacle hold-down PCB pattern 830.

The receptacle hold-down couplers 630 may be provided in plural. The plurality of receptacle hold-down couplers 630 may be coupled to the plurality of receptacle hold-down PCB patterns 830, respectively. In the illustrated embodiment, the receptacle hold-down coupler 630 consists of a pair spaced apart in the Y-axis direction and one located between the pair.

The receptacle contact 700 is in contact with and electrical connected to the plug contact 300. The receptacle contact 700 substantially performs a function of electrically connecting a module substrate (not shown) coupled to the plug 10 and a module substrate (not shown) coupled to the receptacle 20. The receptacle contact 700 may exchange electrical signals or currents with the plug contact 300.

The receptacle contact 700 may be formed of an electrically conductive material. In addition, the receptacle contact 700 may be formed of a material having a predetermined elasticity. In an embodiment, the receptacle contact 700 may be formed of a metal material such as copper or an alloy including the same.

The receptacle contact 700 is coupled to the receptacle insulator 500. The receptacle contact 700 may be supported by being coupled to the receptacle support wall 520.

The receptacle contacts 700 may be provided in plural. The plurality of receptacle contacts 700 may be arranged to be spaced apart from each other in the longitudinal direction of the receptacle support wall 520, that is, the X-axis direction in the illustrated embodiment.

In the receptacle 20 according to an embodiment of the present disclosure, a plurality of receptacle contacts 700 may be disposed to be spaced apart by a minimum distance. Accordingly, the length of the receptacle 20, that is, the length in the X-axis direction in the illustrated embodiment, may be reduced.

In addition, the receptacle 20 according to an embodiment of the present disclosure may prevent unintended contact and electrical conduction between the plurality of receptacle contacts 700 disposed adjacent to each other or the receptacle PCB patterns 800 coupled to the receptacle contacts 700, respectively. To this end, as will be described later, the plurality of receptacle contacts 700 may be coupled to the receptacle PCB pattern 800 at different locations along the arrangement direction thereof.

In this case, as will be described later, the plurality of receptacle contacts 700 may include a first receptacle contact 700a where the receptacle contact mounter 740 is located at one side, that is, the front side, in the Y-axis direction, and a second receptacle contact 700b where the receptacle contact mounter 740 is located at the other side, that is, the rear side, in the Y-axis direction.

The first and second receptacle contacts 700a and 700b are alternately disposed along the direction in which the plurality of receptacle contacts 700 are spaced apart from each other in parallel, that is, the X-axis direction.

The first receptacle contact 700a and the second receptacle contact 700b are different in the direction of coupling with the receptacle support wall 520 and the position of coupling with the receptacle PCB pattern 800, but their structures are the same. Therefore, common parts in the following description will be described by collectively named the first and second receptacle contacts 700a and 700b as receptacle contact 700.

In the illustrated embodiment, the receptacle contact 700 includes a receptacle contactor 710, a receptacle contact supporter 720, a receptacle coupling space 730, and a receptacle contact mounter 740.

The receptacle contactor 710 is a portion where the receptacle contact 700 is coupled to the receptacle contact 700. The receptacle contactor 710 is in contact with and electrically connected to the receptacle contactor 710 of the receptacle contact 700. The receptacle contactor 710 constitutes a portion of the receptacle contact 700.

The receptacle contactor 710 provided in the first receptacle contact 700a is located toward one side in the Y-axis direction, that is, toward the front side in the illustrated embodiment. In addition, the receptacle contactor 710 provided in the second receptacle contact 700b is located toward the other side in the Y-axis direction, that is, toward the rear side in the illustrated embodiment.

Therefore, the receptacle contactors 710 provided in each receptacle contact 700 are alternately located at one side and the other side of the Y-axis along the X-axis direction, respectively. As a result, the position of the receptacle contact portions 710 in contact with and electrical connected to the plug contact portion 310 of the plug contact 300 is formed in a zigzag shape along the X-axis direction and the Y-axis direction.

Therefore, a position where the plug contact unit 310 provided in each of the plurality of plug contacts 300 and the receptacle contactor 710 provided in each of the plurality of receptacle contacts 700 are coupled is also formed in a zigzag shape along the X-axis direction and Y-axis direction.

As will be described later, the receptacle contactor 710 is located opposite to the receptacle contact mounter 740 along the Y-axis direction. Therefore, it will be understood that the receptacle contact mounter 740 provided in each receptacle contact 700 and the receptacle contact PCB patterns 810 and 820 each coupled thereto are also formed in a zigzag shape along the X-axis direction and the Y-axis direction.

In the illustrated embodiment, the receptacle contactor 710 includes a first receptacle contactor 711, a second receptacle contactor 712, and a receptacle contact connector 713.

The first receptacle contactor 711 constitutes a portion where the receptacle contactor 710 is in contact with the receptacle contactor 710. The first receptacle contactor 711 is in contact with and electrical connected to the first plug contactor 311 or the second plug contactor 312.

The first receptacle contactor 711 is formed to be rounded to be convex toward the outside. In other words, the first receptacle contactor 711 extends curved. The first receptacle contactor 711 forms one end of the receptacle contact 700. Based on the first receptacle contact 700a, the first receptacle contactor 711 forms the rear end of the receptacle contact 700.

The first receptacle contactor 711 is continuous with the first receptacle contact supporter 721. The first receptacle contactor 711 is continuous with the second receptacle contactor 712 through the receptacle contact connector 713.

The second receptacle contactor 712 constitutes another portion where the receptacle contactor 710 is in contact with the receptacle contactor 710. The second receptacle contactor 712 is in contact with and electrical connected to the first plug contactor 311 or the second plug contactor 312.

The second receptacle contactor 712 is formed to protrude toward the outside. In other words, the second receptacle contactor 712 protrudes from the first receptacle contact supporter 721 toward the first receptacle contactor 711.

The receptacle contact connector 713 forms another configuration of the receptacle contactor 710. The receptacle contact connector 713 extends between the first receptacle contactor 711 and the first receptacle contact supporter 721. The receptacle contact connector 713 is continuous with the first receptacle contactor 711 and the first receptacle contact supporter 721, respectively.

The receptacle contact connector 713 may be formed to have different widths along its extension direction. In the illustrated embodiment, the receptacle contact connector 713 extends along the Y-axis direction, and the length of the receptacle contact connector 713 in the X-axis direction is changed along the extension direction.

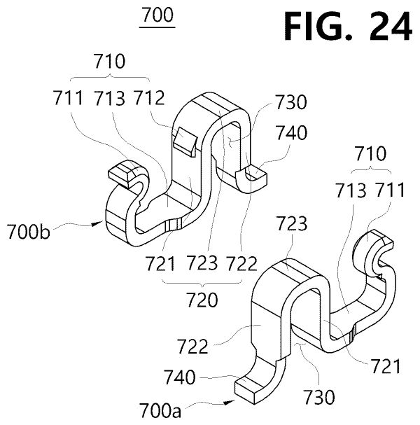

That is, as shown in FIGS. 24 to 26, a portion of the receptacle contact connector 713 that is continuous with the first receptacle contactor 711, that is, the front side of the first receptacle contact 700a, is formed to have a width of the first receptacle width rw1. In this case, the first receptacle width rw1 may be defined as the width of the first receptacle contactor 711.

In addition, a portion of the receptacle contact connector 713 that is continuous with the second receptacle contactor 712, that is, the rear side of the first receptacle contact 700a, is formed to have a width of the second receptacle width rw2. In this case, the second receptacle width rw2 may be defined as the width of the second receptacle contact supporter 722 or the receptacle support connector 723.

At this time, as shown in the drawing, the first receptacle width rw1 is formed shorter than the second receptacle width rw2. Therefore, the width of the receptacle contact connector 713 of the first receptacle contact 700a increases toward the rear side, and the width of the receptacle contact connector 713 of the second receptacle contact 700b decreases toward the rear side.

Therefore, even if the separation distance between the first and second receptacle contacts 700a and 700b located adjacent to each other is reduced, contact between the receptacle contactor 710 may be prevented. Accordingly, the plurality of receptacle contacts 700 may be electrically insulated while being spaced apart by a minimum distance.

The receptacle contact supporter 720 is a portion where the receptacle contact 700 is coupled to the receptacle support wall 520. The receptacle contact support 720 partially surrounds the receptacle support wall 520. In the illustrated embodiment, the receptacle contact supporter 720 is configured to cover the front side, the upper side, and the lower side of the receptacle support wall 520.

The receptacle contact supporter 720 is continuous with the receptacle contactor 710. The receptacle contact supporter 720 is continuous with the second receptacle contactor 712 and the receptacle contact connector 713, respectively.

The receptacle contact supporter 720 partially surrounds the receptacle coupling space 730. In the illustrated embodiment, the receptacle contact supporter 720 surrounds the upper, front, and rear sides of the receptacle coupling space 730. Accordingly, the plug support wall 520 accommodated in the plug coupling space 730 may also be surrounded by the receptacle contact supporter 720 on the upper, front, and rear sides thereof.

The receptacle contact supporter 720 is continuous with the receptacle contact mounter 740. Therefore, it may be said that the receptacle contact supporter 720 extends between the receptacle contactor 710 and the receptacle contact mounter 740.

In the illustrated embodiment, the receptacle contact supporter 720 includes a first receptacle contact supporter 721, a second receptacle contact supporter 722, and a receptacle support connector 723.

The first receptacle contact supporter 721 constitutes a portion of the receptacle contact supporter 720. The first receptacle contact supporter 721 surrounds a portion of the receptacle support wall 520. In the embodiment shown, the first receptacle contact supporter 721 surrounds the front side or the rear side of the receptacle support wall 520.

The first receptacle contact supporter 721 is continuous with the first receptacle contactor 711 through the receptacle contact connector 713. The second receptacle contactor 712 is located on one surface facing the first receptacle contactor 711 among the surfaces of the first receptacle contact supporter 721.

The first receptacle contact supporter 721 is continuous with the second receptacle contact supporter 722 through the receptacle support connector 723.

The second receptacle contact supporter 722 constitutes another portion of the receptacle contact supporter 720. The second receptacle contact supporter 722 surrounds another portion of the receptacle support wall 520. In the illustrated embodiment, the second receptacle contact supporter 722 surrounds the front side or the back side of the receptacle support wall 520.

The second receptacle contact supporter 722 is continuous with the first receptacle contact supporter 721 through the receptacle support connector 723. The second receptacle contact supporter 722 is continuous with the receptacle contact mounter 740. The second receptacle contact supporter 722 extends between the receptacle support connector 723 and the receptacle contact mounter 740.

The receptacle support connector 723 constitutes the rest of the receptacle contact supporter 720. The receptacle support connector 723 covers another portion of the receptacle support wall 520. In the illustrated embodiment, the receptacle support connector 723 covers the upper side of the receptacle support wall 520.

The receptacle support connector 723 is continuous with the first and second receptacle contact supporters 721 and 722, respectively. The receptacle support connector 723 extends between the first and second receptacle contact supporters 721 and 722.

The receptacle coupling space 730 is a portion in which the receptacle contact 700 accommodates the receptacle support wall 520. The receptacle coupling space 730 is defined by being partially surrounded by the receptacle contact supporter 720. In the illustrated embodiment, the upper side, the front side, and the lower side of the receptacle coupling space 730 are surrounded by the receptacle contact supporter 720. The lower side of the receptacle coupling space 730 may be opened, so that the receptacle support wall 520 may be accommodated.

The receptacle contact mounter 740 is a portion in which the receptacle contact 700 is coupled to the receptacle PCB pattern 800. The receptacle contact mounter 740 is exposed to the outside of the receptacle insulation body 510 or the receptacle through-hole 530.

The receptacle contact mounter 740 is continuous with the receptacle contact supporter 720. In the illustrated embodiment, the end portion of the receptacle contact mounter 740 in the Y-axis direction is continuous with the receptacle second receptacle contact supporter 722.

The receptacle contact mounter 740 provided in the first receptacle contact 700a and the second receptacle contact 700b, respectively, may be alternately arranged in the Y-axis direction along the X-axis direction.

That is, as best shown in FIGS. 20 to 23, the first and second receptacle contacts 700a and 700b are alternately arranged along the X-axis direction. The receptacle contact mounter 740 provided in the first receptacle contact 700a is located at one side in the Y-axis direction, that is, at the rear side in the illustrated embodiment. The receptacle contact mounter 740 provided in the second receptacle contact 700b is located at the other side in the Y-axis direction, that is, at the front side in the illustrated embodiment.

In addition, the pair of first receptacle contacts 700a or the pair of second receptacle contacts 700b are disposed to be spaced apart from each other along the Y-axis direction. Therefore, the receptacle contact mounter 740 provided in the pair of receptacle contacts 700a disposed along the Y-axis direction is located at one side or the other side in the Y-axis direction.

As described above, the receptacle support wall 520 is configured to include the first to fourth receptacle support walls 521, 522, 523, and 524. In the illustrated embodiment, the first receptacle contact 700a is coupled to the first and third receptacle support walls 521 and 523. In addition, the second receptacle contact 700b is coupled to the second and fourth receptacle support walls 522 and 524.

Therefore, the first and second receptacle contacts 700b are alternately arranged in the first and second receptacle support walls 521 and 522. Similarly, the first and second receptacle contacts 700b are alternately arranged in the third and fourth receptacle support walls 523, 524.

In this case, the receptacle contact mounter 740 of the first receptacle contact 700a is coupled to the first receptacle contact PCB pattern 810 located to be biased toward the front side. In addition, the receptacle contact mounting portion 740 of the second receptacle contact 700b is coupled to the second receptacle contact PCB pattern 820 located to be biased toward the rear side.

As a result, it will be understood that the receptacle contact mounter 740 provided in each receptacle contact 700 and the receptacle PCB pattern 800 coupled thereto are alternately biased in the front side and the rear side along the X-axis direction.

Accordingly, a receptacle contact mounter 740 coupled to the receptacle PCB pattern 800 and a receptacle contact mounter 740 not coupled to the receptacle PCB pattern 800 are alternately arranged along the longitudinal direction of the receptacle 20, that is, the X-axis direction.

In other words, one of the receptacle contact mounters 740 disposed adjacent to each other along the X-axis direction is coupled to the receptacle PCB pattern 800, and the other is not coupled to the receptacle PCB pattern 800.

Therefore, the first and second receptacle contact PCB patterns 810 and 820 are disposed to face each other with the receptacle contact mounter 740 interposed therebetween along the X-axis direction. Accordingly, the adjacent first and second receptacle contact PCB patterns 810 and 820 may be sufficiently spaced apart, thereby preventing arbitrary contact or electrical connection between them.

Also, a pair of first receptacle contacts 700a or a pair of second receptacle contacts 700b are disposed along the Y-axis direction. Accordingly, the receptacle contact mounter 740 provided in the pair of receptacle contacts 700 arranged side by side along the Y-axis direction is biased to one side or the other side, that is, the front side and the rear side in the Y-axis direction.

Therefore, the pair of receptacle contact mounters 740 may be sufficiently spaced apart along the Y-axis direction.

As a result, the first and second receptacle contacts 700a and 700b adjacent to each other may be spaced apart by a minimum distance while maintaining the reliability of the electrical connection. Accordingly, the size of the plug 10, especially the length in the X-axis direction, may be reduced.

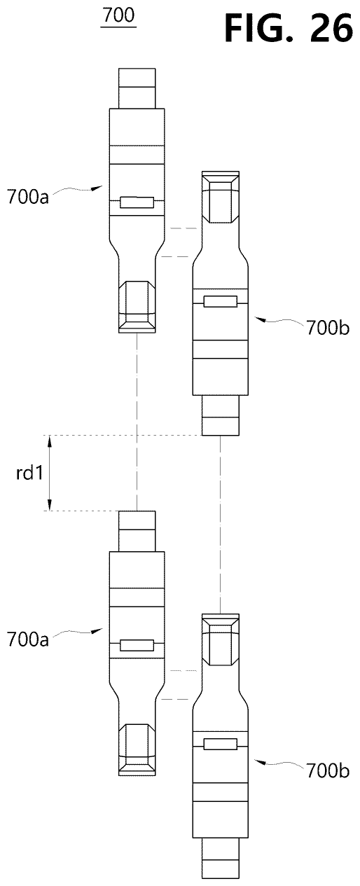

Meanwhile, as shown in FIG. 26, the first and second receptacle contacts 700a and 700b arranged side by side along the Y-axis direction may be disposed to be spaced apart by a predetermined distance, that is, the first receptacle distance rd1.

In addition, as shown in FIGS. 22 and 23, the receptacle through-hole 530 may be formed to have a width as much as the second receptacle distance rd2 along the Y-axis direction.

In this case, the first receptacle distance rd1 is preferably formed long enough so that the first receptacle contact 700a or the second receptacle contact 700b disposed to face each other along the Y-axis direction and the first and second receptacle contact PCB patterns 810 and 820 coupled thereto are not in contact with each other. In addition, the first receptacle distance rd1 is formed to be less than or equal to the second receptacle distance rd2, so that one of the receptacle contact mounters 740 of the pair of receptacle contacts 700 is preferably exposed at least partially through the receptacle through-hole 530.

The receptacle PCB pattern 800 couples the receptacle 20 to a module substrate (not shown). Specifically, the receptacle PCB pattern 800 couples the receptacle hold-down 600 and the receptacle contact 700 to the module substrate (not shown).

The receptacle PCB pattern 800 may be formed in an arbitrary form that allows the receptacle hold-down 600 and the receptacle contact 700 to be coupled to the module substrate (not shown). In an embodiment, the receptacle PCB pattern 800 may be configured in the form of soldering.

The receptacle PCB pattern 800 may be formed in plural. The plurality of receptacle PCB patterns 800 may be coupled to receptacle hold-down 600 and receptacle contact 700, respectively. In the illustrated embodiment, the receptacle PCB pattern 800 includes a first receptacle contact PCB pattern 810, a second receptacle contact PCB pattern 820, and a receptacle hold-down PCB pattern 830.

The first receptacle contact PCB pattern 810 is coupled to the first receptacle contact 700a. The first receptacle contact PCB pattern 810 is located adjacent to the first receptacle support wall 521 and the third receptacle support wall 523, and is coupled to the plurality of first receptacle contacts 700a, respectively.

The first receptacle contact PCB pattern 810 may be provided in plural. The plurality of first receptacle contact PCB patterns 810 may be coupled to the plurality of first receptacle contacts 700a along the X-axis direction. As described above, the first and second receptacle contacts 700a and 700b are alternately arranged along the X-axis direction.

Accordingly, it may be said that the first receptacle contact PCB pattern 810 is alternately disposed with a plurality of receptacle contacts 700 arranged side by side along the X-axis direction. In other words, along the X-axis direction, a first receptacle contact 700a coupled to the first receptacle contact PCB pattern 810 and a second receptacle contact 700b not coupled to the first receptacle contact PCB pattern 810 (i.e., coupled to the second receptacle contact PCB pattern 820) are alternately arranged.

In addition, the plurality of first receptacle contact PCB patterns 810 may be coupled to a pair of first receptacle contacts 700a arranged side by side along the Y-axis direction.

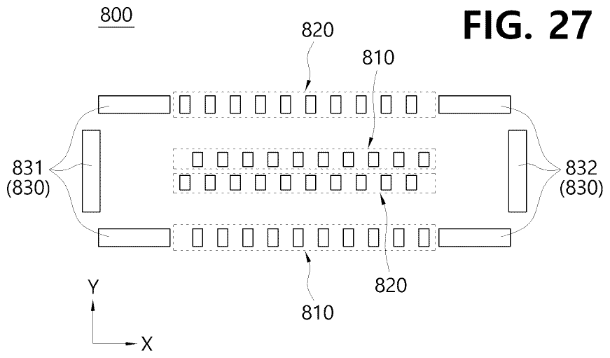

Therefore, as best shown in FIG. 27, the plurality of first receptacle contact PCB patterns 810 may be disposed to be spaced apart from each other along the X-axis direction and the Y-axis direction. As a result, arbitrary contact or electrical connection between the first receptacle contact PCB pattern 810 positioned adjacent to each other may be prevented.

The second receptacle contact PCB pattern 820 is coupled to the second receptacle contact 700b. The second receptacle contact PCB pattern 820 is located adjacent to the second receptacle support wall 522 and the fourth receptacle support wall 524, and is coupled to the plurality of second receptacle contacts 700b, respectively.

The second receptacle contact PCB pattern 820 may be provided in plural. The plurality of second receptacle contact PCB patterns 820 may be coupled to a plurality of second receptacle contacts 700b along the X-axis direction. As described above, the first and second receptacle contacts 700a and 700b are alternately disposed along the X-axis direction.

Accordingly, it may be said that the second receptacle contact PCB pattern 820 is alternately arranged with the plurality of receptacle contacts 700 arranged side by side along the X-axis direction. In other words, along the X-axis direction, a second receptacle contact 700b coupled to the second receptacle contact PCB pattern 820 and a first receptacle contact 700a not coupled to the second receptacle contact PCB pattern 820 (i.e., coupled to the first receptacle contact PCB pattern 810) are alternately arranged.

In addition, the plurality of second receptacle contact PCB patterns 820 may be coupled to a pair of second receptacle contacts 700b arranged side by side along the Y-axis direction.

Therefore, as best shown in FIG. 27, the plurality of second receptacle contact PCB patterns 820 may be disposed to be spaced apart from each other along the X-axis direction and the Y-axis direction. As a result, an arbitrary contact or electrical connection between the second receptacle contact PCB pattern 820 located adjacent to each other may be prevented.

The receptacle hold-down PCB pattern 830 is coupled to the receptacle hold-down 600. The receptacle hold-down PCB pattern 830 is coupled to the receptacle hold-down coupler 630 to increase the coupling force between the receptacle insulator 500 and the receptacle hold-down 600.

The receptacle hold-down PCB pattern 830 may be provided in plural. The plurality of receptacle hold-down PCB patterns 830 may be coupled to the receptacle hold-down couplers 630 provided in the plurality of receptacle hold-downs 600a and 600b, respectively.

In the illustrated embodiment, the receptacle hold-down PCB pattern 830 is configured to include first and second receptacle hold-down PCB patterns 831 and 832. The first receptacle hold-down PCB pattern 831 is coupled to the receptacle hold-down coupler 630 of the first receptacle hold-down 600a and the receptacle hold-down PCB pattern 832 is coupled to the receptacle hold-down coupler 630 of the second receptacle hold-down 600b, respectively.

The receptacle hold-down PCB pattern 830 may be spaced apart from the first and second receptacle contact PCB patterns 810 and 820. In the illustrated embodiment, the receptacle hold-down PCB pattern 830 is disposed to be spaced apart from the first and second receptacle contact PCB patterns 810 and 820 along the X-axis direction, respectively.

Although exemplary embodiments of the present disclosure have been described, the idea of the present disclosure is not limited to the embodiments set forth herein. Those of ordinary skill in the art who understand the idea of the present disclosure may easily propose other embodiments through supplement, change, removal, addition, etc. of elements within the same idea, but the embodiments will be also within the scope of the present disclosure.

| | |
|---|---|
| 10: plug | 20: receptacle |
| 100: plug insulator | 110: plug insulation body |
| 120: plug support wall | 121: first plug support wall |
| 122: second plug support wall | 130: plug through-hole |
| 200: plug hold-down | 200a: first plug hold-down |
| 200b: second plug hold-down | 210: plug hold-down inner surface |
| 220: plug hold-down outer surface | 230: plug hold-down coupler |
| 300: plug contact | 300a: first plug contact |
| 300b: second plug contact | 310: plug contactor |
| 311: first plug contactor | 312: second plug contactor |
| 313: plug contact connector | 320: plug contact mounter |
| 321: first plug contact mounter | 322: second plug contact mounter |
| 330: plug coupling space | 400: plug PCB pattern |
| 410: first plug contact PCB pattern | 420: second plug contact PCB pattern |
| 430: plug hold-down PCB pattern | 431: first plug hold-down PCB pattern |
| 432: second plug hold-down PCB pattern | 500: receptacle insulator |
| 510: receptacle insulation body | 520: receptacle support wall |
| 521: first receptacle support wall | 522: second receptacle support wall |
| 523: third receptacle support wall | 524: fourth receptacle support wall |
| 530: receptacle through-hole | 540: receptacle connection wall |
| 600: receptacle hold-down | 600a: first receptacle hold-down |
| 600b: second receptacle hold-down | 610: upper receptacle hold-down |
| 620: side receptacle hold-down | 630: receptacle hold-down coupler |
| 700: receptacle contact | 700a: first receptacle contact |
| 700b: second receptacle contact | 710: receptacle contactor |
| 711: first receptacle contactor | 712: second receptacle contactor |
| 713: receptacle contact connector | 720: receptacle contact supporter |
| 721: first receptacle contact supporter | 722: second receptacle contact supporter |
| 723: receptacle support connector | 730: receptacle coupling space |
| 740: receptacle contact mounter | 800: receptacle PCB pattern. |
| 810: first receptacle contact PCB pattern | 820: second receptacle contact PCB pattern |
| 830: receptacle hold-down PCB pattern | 831: first receptacle hold-down PCB pattern |
| 832: second receptacle hold-down PCB pattern | |
| pd1: first plug distance | pd2: second plug distance |
| pw1: first plug width | pw2: second plug width |
| rw1: first receptacle width | rw2: second receptacle width |
| rd1: first receptacle distance | rd2: second receptacle distance |

1. A connector comprising:
a plug insulator configured to have a length in a first direction and have a width in a second direction orthogonal to the first direction; and
a plurality of plug contacts configured to be coupled to the plug insulator, respectively coupled to and electrically connected to a plurality of receptacle contacts provided on a receptacle, and spaced apart from each other along the first direction,
wherein one of each pair of the plug contacts arranged to be adjacent to each other is in contact with a first receptacle contactor operatively movably provided on the receptacle contacts at one side in the second direction, and the other thereof is in contact with the first receptacle contactor at the other side in the second direction.

2. The connector of claim 1, wherein the one of each pair of the plug contacts arranged to be adjacent to each other is coupled to a plug PCB pattern at the one side in the second direction, and the other thereof is coupled to the plug PCB pattern at the other side in the second direction.

3. The connector of claim 2, wherein the plug insulator includes:
a plug insulation body configured to have a length in the first direction and have a width in the second direction; and
a plug through-hole configured to penetrate through the inside of the plug insulation body 110,
wherein each of the plug contacts extends in the second direction, and one end of which is exposed to the outside of the plug insulation body, and the other end of which is located in the plug through-hole.

4. The connector of claim 3, wherein each of the plug contacts includes:
a plug contactor coupled to the plug insulator; and
a plug contact mounter continuous with the plug contactor and coupled to the plug PCB pattern.

5. The connector of claim 4, wherein the plug contact mounter includes:
a first plug contact mounter located at one end in the second direction; and
a second plug contact mounter located at the other end in the second direction,
wherein one of each pair of the plug contacts located adjacent to each other among the plurality of the plug contacts has the first plug contact mounter located at the outside of the plug insulation body along the second direction, and
the other thereof has the first plug contact mounter located in the plug through-hole.

6. The connector of claim 5, further comprising:
a plurality of the plug PCB patterns coupled to and electrical connected to the plurality of the plug contacts,
wherein the plug PCB patterns are alternately coupled to the first plug contact mounter and the second plug contact mounter of the plurality of the plug contacts arranged to be spaced apart from each other along the second direction.

7. The connector of claim 4, wherein the plug contactor includes:
a first plug contactor located at one side of the second direction and in contact with the external receptacle and formed to have a length of a first plug width pw1 along the first direction; and
a second plug contactor located at the other side of the second direction and in contact with the receptacle and formed to have a length of a second plug width pw2 along the first direction.

8. The connector of claim 7, wherein the plug contactor includes:
a plug contact connector configured to extend between the first plug contactor and the second plug contactor,
wherein the first plug contactor and the second plug contactor are configured to have different widths along the first direction, and the plug contact connector is configured such that the width in the first direction changes along the second direction.

9. A connector comprising:
a receptacle insulator configured to have a length in a first direction and have a width in a second direction orthogonal to the first direction; and
a plurality of receptacle contacts configured to be coupled to the receptacle insulator, respectively coupled to and electrically connected to a plurality of plug contacts provided on a plug 10, and spaced apart from each other along the first direction,
wherein a first receptacle contactor operatively movably provided on one of each pair of the receptacle contacts arranged to be adjacent to each other is in contact with a plug contactor of the plug contact at one side in the second direction, and the first receptacle contactor operatively movably provided on the other thereof is in contact with the plug contactor at the other side in the second direction.

10. The connector of claim 9, wherein the one of each pair of the receptacle contacts arranged to be adjacent to each other is coupled to a receptacle PCB pattern at the one side in the second direction, and the other thereof is coupled to the receptacle PCB pattern at the other side in the second direction.

11. The connector of claim 10, wherein the receptacle insulator includes:
a receptacle insulation body configured to have a length in the first direction and have a width in the second direction; and
a receptacle through-hole configured to penetrate through the inside the receptacle insulation body,
wherein each of the receptacle contacts extends in the second direction, and one end of which is located toward the receptacle through-hole, and the other end of which is located toward the outside of the receptacle insulation body along the second direction.

12. The connector of claim 11, wherein the connector include:
a receptacle contact supporter coupled to the receptacle insulator,
wherein the receptacle contact supporter includes:
a first receptacle contact supporter located at one side along the second direction; and
a second receptacle contact supporter continuous with the first receptacle contact supporter and located at the other side along the second direction,
wherein one of each pair of the receptacle contacts located adjacent to each other among the plurality of the receptacle contacts has the first receptacle contact supporter disposed to face the receptacle through-hole, and the other thereof has the second receptacle contact supporter disposed to face the receptacle through-hole.

13. The connector of claim 12, wherein the receptacle contact includes:
a receptacle contact mounter continuous with the receptacle contact supporter, coupled to the receptacle PCB pattern, and located adjacent to the second receptacle contact supporter, and
wherein in the plurality of receptacle contacts, the one of the receptacle contact mounter disposed to face the receptacle through-hole and the other of the receptacle contact mounter disposed to face the second direction outside of the receptacle insulation body are alternately disposed along the first direction, and
wherein in the receptacle PCB patterns, the one of the receptacle contact mounter disposed to face the receptacle through-hole and the other of the receptacle insulation body disposed to face the second direction outside are alternately arranged along the first direction.

14. The connector of claim 10, wherein the receptacle insulator includes:
a receptacle insulation body configured to have a length in the first direction and a width in the second direction; and
a plurality of receptacle support walls configured to have a length in the first direction, coupled to the receptacle contacts, and disposed to be spaced apart from each other along the second direction,
wherein the plurality of receptacle contacts are coupled to the plurality of receptacle support walls, respectively, and disposed to be spaced apart from each other along the first direction.

15. The connector of claim 14, wherein the receptacle insulator includes:
a receptacle through-hole configured to penetrate through the inside of the receptacle insulation body,
wherein the receptacle support wall includes:
a first receptacle support wall and a second receptacle support wall located at one side of the second direction and disposed to be spaced apart from each other along the second direction; and
a third receptacle support wall and a fourth receptacle support wall located at the other side of the second direction and disposed to be spaced apart from each other along the second direction,
wherein the first and second receptacle support walls and are disposed to face the third and fourth receptacle support walls and with the receptacle through-hole interposed therebetween along the second direction.

16. The connector of claim 15, wherein one of the plurality of receptacle contacts is alternately coupled to the first and second receptacle support walls and along the first direction, respectively and
the other of the plurality of receptacle contacts is alternately coupled to the third and fourth receptacle support walls and along the first direction,
wherein the receptacle contacts coupled to the first and third receptacle support walls and are located at one side along the second direction, and the receptacle contacts coupled to the second and fourth receptacle support walls and are located at the other side along the second direction.

17. The connector of claim 16, further comprising:
the plurality of receptacle PCB patterns coupled to and electrically connected to the plurality of receptacle contacts,
wherein the receptacle PCB patterns includes:
a first receptacle contact PCB patterns coupled to the receptacle contacts coupled to the first and third receptacle support walls and; and
a second receptacle contact PCB patterns coupled to the receptacle contacts coupled to the second and fourth receptacle support walls and,
wherein the first receptacle contact PCB patterns and the second receptacle contact PCB patterns are alternately arranged along the first direction.
